(19) United States
(12) Patent Application Publication
(10) Pub. No.: US 2019/0126670 A1
(43) Pub. Date: May 2, 2019

(54) SYSTEMS AND METHODS FOR A HIGH STRENGTH SPOKE LACED WHEEL WITH REDUCED WEIGHT INCLUDING FORCE SPECIFIC LACING

(71) Applicant: 8150 Truth Limited, Littleton, CO (US)

(72) Inventors: Jamas Stiber, Littleton, CO (US); Bradley Flynn, Littleton, CO (US)

(21) Appl. No.: 15/999,232

(22) Filed: Aug. 17, 2018

Related U.S. Application Data
(60) Provisional application No. 62/547,015, filed on Aug. 17, 2017.

(51) Int. Cl. B60B 1/02; B60B 1/00; B60B 1/04; B60B 21/10

(52) U.S. Cl. CPC B60B 1/0246; B60B 1/003; B60B 1/041; B60B 1/044; B60B 2320/10; B60B 2360/10; B60B 2360/104; B60B 2900/311; B60B 21/10

(57) ABSTRACT

A wheel for a two wheeled vehicle including a flange and a plurality of spokes, the spokes connecting the rim to the flange, wherein brake force spokes of the plurality of spokes are stronger than drive force spokes of the plurality of spokes. In one alternative, the flange has an inner and an outer area.

### CROSS REFERENCE TO RELATED APPLICATION

This non-provisional application claims the benefit of and priority to U.S. Provisional Patent Application No. 62/547,015 filed Feb. 17, 2017, which is incorporated herein by reference in its entirety.

### BACKGROUND

In various activities involving vehicles with spokes, both the strength and weight are important considerations in the wheel design. Therefore, it is desirable to use spoke configurations and spoke strengths that maximize strength and minimize weight. It is also desirable to provide a spoke strength that is suitable for the activity while minimizing weight. Typically, spoke arrangements are used in two wheeled vehicles, such as bicycles.

### SUMMARY

In one embodiment, a wheel for a two wheeled vehicle includes a flange and a plurality of spokes, the spokes connecting the rim to the flange, wherein brake force spokes of the plurality of spokes are stronger than drive force spokes of the plurality of spokes. In one alternative, the flange has an inner and an outer area. In another alternative, the brake force spokes on the brake side of the wheel are attached to the inner area of the flange. Alternatively, the drive force spokes of the brake side of the wheel are attached to the outer area of the flange. Optionally, the drive force spokes on the drive side of the wheel are attached to the inner area of the flange. Alternatively, the brake force spokes on the drive side of the wheel are attached to the outer area of the flange. In another alternative, the wheel is a rear wheel of a bicycle. Alternatively, the brake force spokes are made out thicker gauge spoke than the drive force spokes. Optionally, the brake force spokes are attached to the rim via a brass nipple and the drive force spokes are attached to the rim via an aluminum nipple.

In one embodiment, a two wheeled system for a vehicle includes a first and second wheel, the first and second wheel each having a rim, a flange, and a plurality of spokes, wherein brake force spokes of the plurality of spokes are stronger than drive force spokes of the plurality of spokes. In one alternative, the flange of each of the first and second wheel has an inner and an outer area. In another alternative, the brake force spokes on the brake side of the first wheel are attached to the inner area of the flange of the first wheel. Alternatively, the drive force spokes of the brake side of the first wheel are attached to the outer area of the flange. Optionally, the drive force spokes on the drive side of the first wheel are attached to the inner area of the flange and the brake force spokes on the drive side of the first wheel are attached to the outer area of the flange. Alternatively, for the second wheel, the brake side drive force spokes are attached to the inside flange and the brake side brake force spokes are attached to the outer flange and the non-brake side drive force spokes are attached to the outside flange and the non-brake side brake force spokes are attached to the inner flange. In another alternative, the brake force spokes oil the drive side of the wheel are attached to the outer area of the flange. Optionally, the first wheel is a rear wheel of a bicycle. Alternatively, the brake force spokes are made out thicker gauge spoke than the drive force spokes. Optionally, the brake force spokes are attached to the rim via a brass nipple and the drive force spokes are attached to the rim via an aluminum nipple.

In one embodiment, method of lacing the spokes of a wheel for a vehicle includes providing a rim, a flange, and a plurality of spokes. The method further includes using stronger spokes to attach a first portion of the rim to the flange, where the stronger spokes experience a greater brake force during braking of the vehicle. The method further includes using weaker spokes to attach a second portion of the rim of the flange, wherein the weaker spokes experience a greater brake force during braking of the vehicle; wherein the stronger spokes are stronger than the weaker spokes. In one alternative, on the brake side of the wheel, the stronger spokes attach to an inner portion of the flange. In another alternative, on the brake side of the wheel, the weaker spokes attach to an outer portion of the flange. Alternatively, on the non-brake side of the wheel, the stronger spokes attach to an outer portion of the flange. In another alternative, on the non-brake side of the wheel, the weaker spokes attach to an inner portion of the flange. Optionally, the stronger spokes are made out thicker gauge spoke than the weaker spokes. Alternatively, the stronger spokes are attached to the rim via a brass nipple and the weaker spokes arc attached to the rim via an aluminum nipple.

### BRIEF DESCRIPTION OF THE DRAWINGS

FIG. 1 shows one embodiment of a lacing scheme for a rear wheel of a bike with the side of the wheel having the drive side showing; and

FIG. 2 shows one embodiment of a lacing scheme for a rear wheel of a bike with the side of the wheel having the disk brake showing.

### DETAILED DESCRIPTION

Certain terminology is used herein for convenience only and is not to be taken as a limitation on the embodiments of the systems and methods for a high strength spoke laced wheel with reduced weight including force specific lacing. Generally, this system, referred to as FSL wheel (force specific lacing). Generally, the FSL wheel is for use with vehicles utilizing a single rear drive wheel and disk style brakes. Typically, a FSL wheel is used in conjunction with bicycles. Typically, disc braking force is applied on one side of the wheel and power force (drive force) is also applied on one side of the wheel (the opposite side). In other words the brake disc is located on one side of the spoke structure of the wheel and the power gear is located on one side of the spoke structure. This results in a difference in how forces are applied to the spokes. In many embodiments, spokes of the FSL wheel experiencing more force during braking are spokes that are of stronger materials that may have more weight and cost, while spokes experiencing less force during braking are those made of lighter materials that may be less strong. In many embodiments, on the rear wheel which provides the drive to the vehicle, on the side of the wheel where the drive is applied, spokes on the inside flange will be lighter and less strong and spokes on the outer flange, which will experience more braking force will be stronger (and likely heavier). On the opposite side, spokes on the outside flange will experience less braking force and therefore may be less strong (and likely lighter) and those on the inside flange will be stronger (and likely heavier). In many embodiments, on the non-drive wheel, the side of the wheel with the disk brake portion has spokes attached to the inside flange (drive pull) that are lighter and typically less strong than spokes on the outside flange (brake pull). On the opposite side of the wheel, the spokes on the outer flange (drive pull) are configured to be typically weaker and lighter and the spokes on the inside flange (brake pull) are configured to be stronger. Multiple other uses are possible as well. Other features of embodiments of the device are discussed herein.

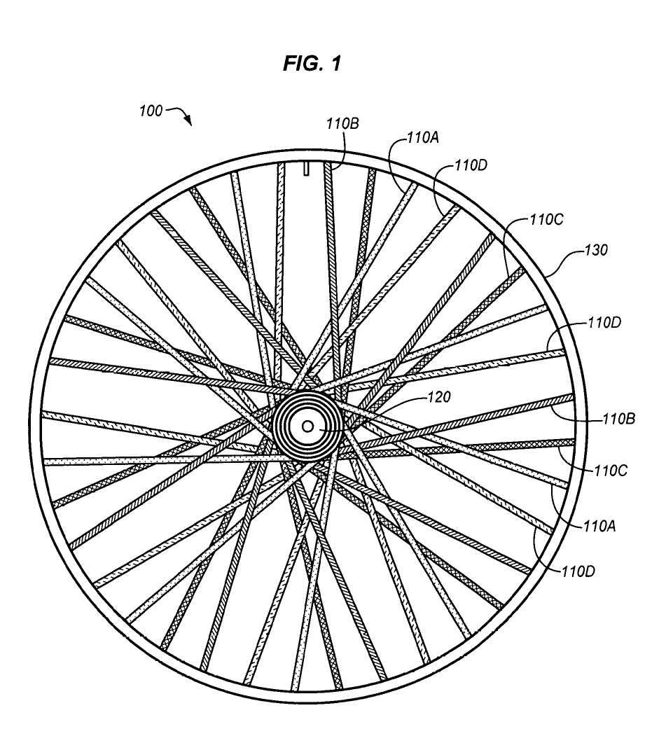

FIG. 1 shows one embodiment of a force specific laced rim and spoke wheel 100 (wheel 100) that includes a plurality of spokes 110, a hub 120, and a rim 130 for a wheel having a drive side flange and a brake side flange. For this embodiment the plurality of spokes 110 come in four varieties, two sets of drive side spokes 110A, 110B and two sets of brake side spokes 110C, 110D. Shading is added in the spokes of the figures for easy identification of the spokes. The drive side spokes 110A are drive pull spokes (or drive force spokes), meaning they are primarily engaged when the wheel 100 is driven by the drive train of a bike or other vehicle in a forward direction. Looking at the wheel 100 shown in FIG. 1, the forward direction is generally clockwise and the drive side is facing out (the brake side is facing away). In many embodiment, drive side spokes 110A are attached at the inside flange of the hub 120 at apertures. In comparison to spoke primarily bearing braking force, in many embodiments drive side spokes 110A may be of a smaller gauge spoke and be attached to rim 130 via an aluminum nipple.

Drive side spokes 110B are brake force spokes (also called brake pull spokes), meaning they are primarily engaged when the wheel 100 is engaged in a braking event and resist a counter clockwise force. In many embodiments, drive side spokes 110B are attached at the outside flange of the hub 120 at apertures. In comparison to spoke primarily bearing acceleration or driving force, in many embodiments drive side spokes 110B may be of a larger gauge spoke and be attached to rim 130 via a brass nipple. For example, drive side spokes 110A may be 14/15 gauge and drive side spokes 110B may be larger gauge triple butted 13/14/15. It is estimated during braking that drive side spokes 110B experience an increased force as compared drive side spokes 110A experience. Based on this configuration, drive side spokes 110A may take up less weight than if they were the same gauge as drive side spokes 110B, resulting in an estimated weight savings of 14 grams spoke/nipple on the scale per wheel vs. a configuration that has all the same gauge spokes throughout a 32 inch wheel.

Brake side spokes are also shown in this FIG. 1: the two sets of brake side spokes 110C, 110D. The brake side spokes 110C are drive pull spokes, meaning they are primarily engaged when the wheel 100 is driven by the drive train of a bike or other vehicle in a forward direction. In many embodiments, drive side spokes 110C are attached at the outside flange of the hub 120 at apertures. In comparison to spokes primarily bearing braking force, in many embodiments drive side spokes 110C may be of a smaller gauge spoke and be attached to rim 130 via an aluminum nipple.

Brake side spokes 110D are brake pull spokes, meaning they are primarily engaged when the wheel 100 is engaged in a braking event and resist a counter clockwise force. In many embodiment, drive side spokes 110D are attached at the inside flange of the hub 120 at apertures. In comparison to spoke primarily bearing acceleration or driving force, in many embodiments drive side spokes 110D may be of a larger gauge spoke and be attached to rim 130 via a brass nipple. For example, drive side spokes 110C may be 14/15 gauge and drive side spokes 110D may be larger gauge triple butted 13/14/15. It is estimated during braking that drive side spokes 110D experience an increased force as compared drive side spokes 110C experience. Based on this configuration, drive side spokes 110C may take up less weight than if they were the same gauge as drive side spokes 110D, resulting in an estimated weight savings of 14 grams spoke/nipple on the scale per wheel vs. a configuration that has all the same gauge spokes throughout a 32 inch wheel.

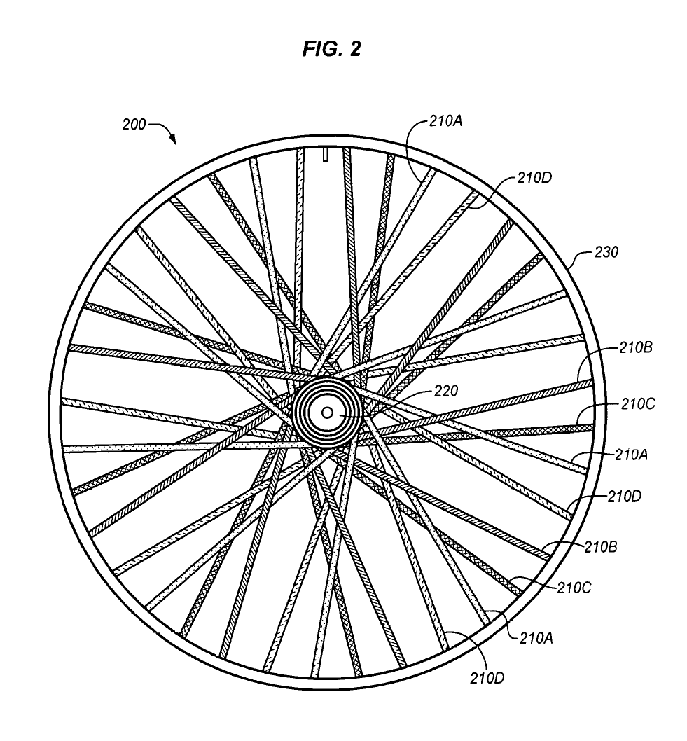

FIG. 2 shows another embodiment of a force specific laced rim and spoke wheel 200 (wheel 200) that includes a plurality of spokes 210, a hub 220, and a rim 230 for a wheel having a drive side flange and a brake side flange. For this embodiment the plurality of spokes 210 come in four varieties, two sets of disc side spokes 210A, 210B and two sets of non-disk side spokes 210C, 210D. The disc side spokes 210A are drive pull spokes, meaning they are primarily engaged when the wheel 100 is driven by the drive train of a bike or other vehicle in a forward direction. Looking at the wheel 200 shown in FIG. 2, the forward direction is generally clockwise and the brake side (or disk side) is facing out. In many embodiments, disc side spokes 210A are attached at the inside flange of the hub 220 at apertures. In comparison to spoke primarily bearing braking force, in many embodiments disk side spokes 210A may be of a smaller gauge spoke and be attached to rim 230 via an aluminum nipple.

Disk side spokes 210B are brake pull spokes, meaning they are primarily engaged when the wheel 200 is engaged in a braking event and resist a counter clockwise force. In many embodiments, disc side spokes 210B are attached at the outside flange of the hub 220 at apertures. In comparison to spoke primarily bearing acceleration or driving force, in many embodiments disc side spokes 210B may be of a larger gauge spoke and be attached to rim 230 via a brass nipple. For example, disk side spokes 210A may be 14/15 gauge and disk side spokes 210B may be larger gauge triple butted 13/14/15. It is estimated during braking that disk side spokes 110B experience an increased force as compared disk side spokes 110A experience. Based on this configuration, disk side spokes 110A may take up less weight than if they were the same gauge as disk side spokes 110B, resulting in an estimated weight savings of 14 grams spoke/nipple on the scale per wheel vs. a configuration that has all the same gauge spokes throughout a 32 inch wheel.

Non disk side spokes are also shown in this FIG. 2: the two sets of non-disk side spokes 210C, 210D. The non-disk side spokes 210C are drive pull spokes, meaning they are primarily engaged when the wheel 200 is driven by the drive train of a bike or other vehicle in a forward direction. In many embodiments, drive side spokes 210C are attached at the outside flange of the hub 120 at apertures. In comparison to spoke primarily bearing braking force, in many embodiments drive side spokes 210C may be of a smaller gauge spoke and be attached to rim 230 via an aluminum nipple.

Non disc side spokes 210D are brake pull spokes, meaning they are primarily engaged when the wheel 200 is engaged in a braking event and resist a counter clockwise force. In many embodiments, drive side spokes 210D are attached at the inside flange of the hub 220 at apertures. In comparison to spoke primarily bearing acceleration or driving force, in many embodiments drive side spokes 210D may be of a larger gauge spoke and be attached to rim 230 via a brass nipple (an aluminum one can be used but brass is preferred for downhill). For example, drive side spokes 210C may be 14/15 gauge and drive side spokes 210D may be larger gauge triple butted 13/14/15. It is estimated during braking that drive side spokes 210D experience an increased force as compared drive side spokes 210C experience. Based on this configuration, drive side spokes 210C may take up less weight than if they were the same gauge as drive side spokes 210D, resulting in an estimated weight savings of 14 grams spoke/nipple on the scale per wheel vs. a configuration that has all the same gauge spokes throughout a 32 inch wheel.

In many embodiments the objective of using certain spokes and their specific arrangement is to achieve Minimal Brake Force Deflection. By placing the spokes on the specific sides of the hub flanges described above you will achieve Minimal Brake Force Deflection. This is because disk brake wheels are dished resulting in an unequal pull angle from each hub flange. Therefore, the spoke receiving greater braking force are made more rigid and stronger. The powerful winding up of the lace, the rim is pulled out of alignment with the rim when the brakes are applied aggressively. Embodiments of the lacing described herein will achieve the minimal amount of this phenomenon. Additionally, the spokes are laced in what is referred to as mirror image lacing.

Power Management Efficiency is the technique of using different gauge spokes for braking pull speed (BPS) and drive pull speed (DPS) to be efficient for the amount of torque being applied. Because of the large difference in the forces on drive pull speed vs. braking pull speed embodiments of the FSL wheel are designed to be strong where it is needed and light where less strength in the spokes will not affect the performance of the wheel.

While specific embodiments have been described in detail in the foregoing detailed description, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

What is claimed as new and desired to be protected by Letters Patent of the United States is:

1. A wheel for a two wheeled vehicle, the wheel comprising:
a rim;
a flange;
a plurality of spokes, the spokes connecting the rim to the flange, wherein brake force spokes of the plurality of spokes are stronger than drive force spokes of the plurality of spokes.

2. The wheel of claim 1, wherein the flange has an inner and an outer area and the brake force spokes on the brake side of the wheel are attached to the inner area of the flange.

3. The wheel of claim 2, wherein the drive force spokes of the brake side of the wheel are attached to the outer area of the flange.

4. The wheel of claim 3, wherein the drive force spokes on the drive side of the wheel are attached to the inner area of the flange.

5. The wheel of claim 4, wherein the brake force spokes on the drive side of the wheel are attached to the outer area of the flange.

6. The wheel of claim 5, wherein the wheel is a rear wheel of a bicycle.

7. The wheel of claim 6, wherein the brake force spokes are made out thicker gauge spoke than the drive force spokes.

8. The wheel of claim 7, wherein the brake force spokes are attached to the rim via a brass nipple and the drive force spokes are attached to the rim via an aluminum nipple.

9. A two wheeled system for a vehicle, the system comprising:
a first and second wheel, the first and second wheel each having a rim, a flange, and a plurality of spokes, wherein brake force spokes of the plurality of spokes are stronger than drive force spokes of the plurality of spokes.

10. The system of claim 9, wherein the flange of each of the first and second wheel has an inner and an outer area and the brake force spokes on the brake side of the first wheel are attached to the inner area of the flange of the first wheel.

11. The system of claim 10, wherein the drive force spokes of the brake side of the first wheel are attached to the outer area of the flange.

12. The system of claim 11, wherein the drive force spokes on the drive side of the first wheel are attached to the inner area of the flange and the brake force spokes on the drive side of the first wheel are attached to the outer are of the flange.

13. The system of claim 12, wherein for the second wheel, the brake side drive force spokes are attached to the inside flange and the brake side brake force spokes are attached to the outer flange and the non-brake side drive force spokes are attached to the outside flange and the non-brake side brake force spokes are attached to the inner flange.

14. The system of claim 13, wherein the brake force spokes on the drive side of the wheel are attached to the outer area of the flange.

15. The system of claim 14, wherein the first wheel is a rear wheel of a bicycle.

16. The system of claim 15, wherein the brake force spokes are made out thicker gauge spoke than the drive force spokes.

17. The system of claim 18, wherein the brake force spokes are attached to the rim via a brass nipple and the drive force spokes are attached to the rim via an aluminum nipple.

18. A method of lacing the spokes of a wheel for a vehicle, the method comprising:
providing a rim, a flange, and a plurality of spokes;
using stronger spokes to attach a first portion of the rim to the flange, where the stronger spokes experience a greater brake force during braking of the vehicle;
using weaker spokes to attach a second portion of the rim of the flange, wherein the weaker spokes experience a greater brake force during braking of the vehicle; wherein the stronger spokes are stronger than the weaker spokes.

19. The method of claim 18, wherein on the brake side of the wheel, the stronger spokes attach to an inner portion of the flange.

20. The method of claim 19, wherein on the brake side of the wheel, the weaker spokes attach to an outer portion of the flange.

21. The method of claim 20, wherein on the non-brake side of the wheel, the stronger spokes attach to an outer portion of the flange.

22. The method of claim 19, wherein on the non-brake side of the wheel, the weaker spokes attach to an inner portion of the flange.
